(19) United States
(12) Patent Application Publication
(10) Pub. No.: US 2022/0163008 A1
(43) Pub. Date: May 26, 2022

(54) Engine

(71) Applicant: Yanmar Power Technology Co., Ltd., Osaka (JP)

(72) Inventor: Tomoaki Kitagawa, Osaka (JP)

(73) Assignee: Yanmar Power Technology Co., Ltd., Osaka (JP)

(21) Appl. No.: 17/440,890

(22) PCT Filed: Mar. 5, 2020
(86) PCT No.: PCT/JP2020/009339

§ 371 Date: Sep. 20, 2021

(30) Foreign Application Priority Data
Mar. 22, 2019 (JP) 2019-054479

(51) Int. Cl. F02M 37/00; F02M 55/02

(52) U.S. Cl. CPC F02M 37/0017; F02M 55/02

(57) ABSTRACT

This engine is provided with multiple injectors, and an excess fuel return pipe. The injectors inject fuel from a fuel tank into a combustion chamber. The excess fuel return pipe returns excess fuel from the injectors to the fuel tank. The excess fuel return pipe is provided with multiple injector connecting pipes and multiple linking pipes. The linking pipes are formed from an elastically deformable hose. Each of the multiple injector connecting pipes is connected to the corresponding injector. Each of the multiple linking pipes links together two mutually adjacent injector connecting pipes. Across the multiple linking pipes, pipe connecting units, to which an injector connecting pipe and a linking pipe are connected, are arranged along the same straight line.

### TECHNICAL FIELD

The present invention relates to an engine including an injector that injects fuel into a combustion chamber.

### BACKGROUND ART

Conventionally, an engine that injects fuel into a combustion chamber via an injector is known. Patent Literature 1 discloses such an engine.

The engine of Patent Literature 1 has a configuration in which fuel is supplied to an injector via a fuel high-pressure pipe that links a fuel supply port of the injector and a fuel discharge port of an adjacent injector.

### CITATION LIST

### Patent Literature

Patent Literature 1: Japanese Unexamined Patent Application Publication No. 2014-156799

### DISCLOSURE OF INVENTION

### Problems to be Solved by the Invention

However, in the configuration of Patent Literature 1, since the fuel high-pressure pipe of a fuel pipe connected to an injector is integrally formed and two fuel high-pressure pipes adjacent to each other are linked via an injector, after the multiple fuel high-pressure pipes are linked in advance, it is not possible to flexibly attend to assemblage needs for mounting them onto the injector. Further, in the configuration of Patent Literature 1, since assemblage work onto injectors is performed in a narrow space between two injectors adjacent to each other, it is difficult to perform the work and there is room for improvement in terms of further improving the ease of assemblage.

The present invention was made in consideration of the above circumstances, and its goal is to provide an engine with which, even in a case where a fuel pipe to be connected to an injector is firstly assembled and then mounted on the injector, an assemblage error that occurs at the timing of mounting can be absorbed and the mounting onto the injector can be easily performed.

### Means for Solving the Problems

### Effect of the Invention

The problem to be solved by the present invention is as described above, and the means for solving this problem and effects of the means will be explained below.

According to an aspect of the present invention, an engine having the configuration below is provided. That is, this engine has an engine body in which a combustion chamber is formed. The engine includes multiple injectors and a fuel pipe. The injectors are configured to inject fuel from a fuel tank into the combustion chamber. The fuel pipe is configured to return excess fuel from the multiple injectors into the fuel tank. The fuel pipe includes multiple first pipes and multiple second pipes. The second pipes are configured with hoses that are elastically deformable. The multiple first pipes are respectively connected to the corresponding injectors. The multiple second pipes respectively link two of the first pipes that are adjacent to each other. Across the multiple second pipes, pipe connecting units with which the first pipes and the second pipes are connected are arranged side by side along the same straight line.

Accordingly, in a case where the fuel pipe is firstly configured in advance by connecting the first pipes and the second pipes and then mounted on the injectors, an assemblage error can be absorbed by elastic deformation of the second pipes which are parts of the fuel pipe. Further, since the pipe connecting units are located side by side along the same straight line, the postures of the first pipes are unlikely to change even if a reaction force is applied to the first pipes in a case where the second pipes are elastically deformed for absorbing an assemblage error or the like. Therefore, the shape of the fuel pipe as a whole can be easily maintained, and thus assemblage to the injectors can be easily performed.

Regarding the engine, it is preferable that the first pipes are mounted on the injectors in a rotatable manner with respect to the injectors.

Accordingly, in the process of mounting the fuel pipe onto the injectors, the orientations of the respective first pipes in relation to the injectors can be changed. Therefore, the fuel pipe can be easily mounted on the injectors.

It is preferable that the above-described engine has the configuration below. That is, the first pipes comprise an injector connecting unit. The injector connecting unit is configured to be connected to the injectors. When viewed in an orientation along the axial direction of the injectors, the injector connecting unit is located so as to overlap the straight line.

Accordingly, even if a reaction force is applied to the first pipes in a case where the second pipes are elastically deformed for absorbing an assemblage error or the like, the reaction force can be received by the first pipes in a well-balanced manner.

It is preferable that the above-described engine has the configuration below. That is, when viewed in an orientation along the axial direction of the injectors, the first pipes are formed in an S-shape. The central parts of the first pipes are connected to the injectors.

Accordingly, the fuel pipe can be arranged while avoiding various surrounding members.

Regarding the engine, it is preferable that the second pipes have a curved shape in a natural state thereof.

Accordingly, the curved shaped second pipes can be easily obtained. Further, since the second pipes are curved from the beginning, a zigzag-shaped fuel pipe can be realized without excessive deformation of the second pipes.

It is preferable that the above-described engine has the configuration below. That is, the injectors comprise a signal line connecting unit to which an electrical signal line is connected. When viewed in a direction perpendicular to both of the height direction of the engine body and the direction of the crankshaft, the first pipes and the signal line connecting unit are arranged to at least partially overlap with each other.

Accordingly, the first pipes and the signal line connecting unit can be compactly arranged.

It is preferable that the above-described engine has the configuration below. That is, the engine body comprises a cylinder head and a head cover. On the cylinder head, the injectors are mounted. The head cover covers the cylinder head. The first pipes are arranged so as to at least partially pass between the signal line connecting unit and the head cover.

Accordingly, the first pipes can be arranged by use of the space between the signal line connecting unit and the head cover. Therefore, compactness of the engine can be achieved.

### BRIEF DESCRIPTION OF DRAWINGS

FIG. 1 is a perspective view illustrating a configuration of an engine according to an embodiment of the present invention.

FIG. 2 is a schematic diagram illustrating an overall configuration of the engine.

FIG. 3 is a perspective view illustrating a configuration of an engine body.

FIG. 4 is a side view illustrating the configuration of the engine body.

FIG. 5 is a diagram illustrating the arrangement of an excess fuel return pipe as viewed in the axial direction of injectors.

FIG. 6 is a perspective view illustrating how an injector connecting pipe is mounted on an injector.

### DESCRIPTION OF EMBODIMENTS

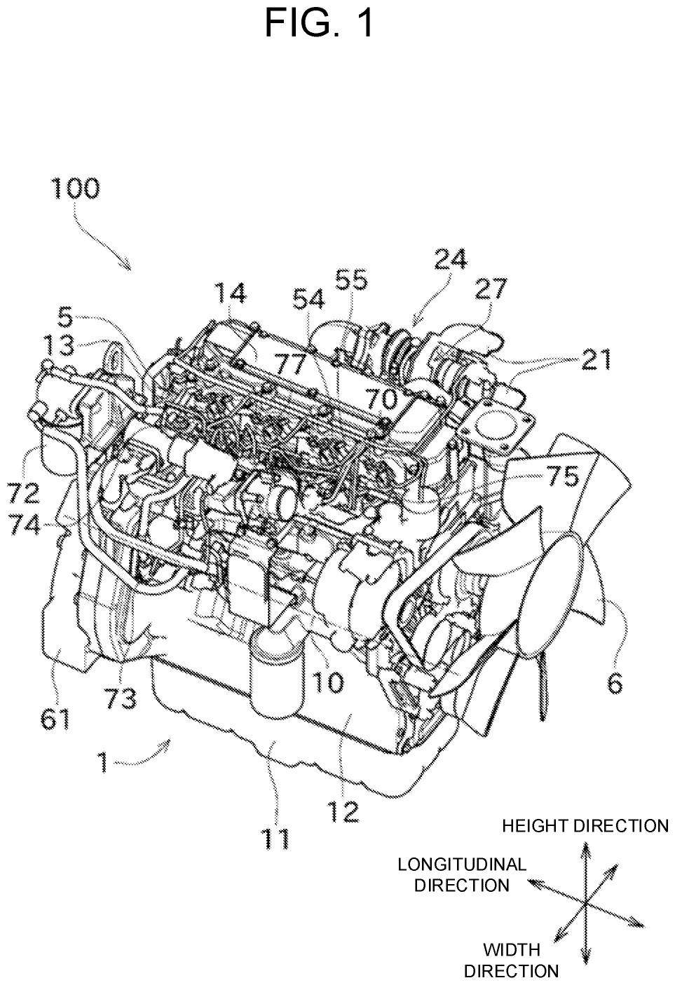

Next, an explanation will be given of an embodiment of the present invention with reference to the drawings. FIG. 1 is a perspective view illustrating a configuration of the engine 100 according to an embodiment of the present invention.

The engine 100 illustrated in FIG. 1 is a diesel engine, which is to be mounted on, for example, an agricultural machine such as a tractor, a construction machine such as an excavator, etc. The engine 100 is configured as, for example, an in-line 4-cylinder engine having four cylinders. Note that the number of cylinders is not limited to four. The engine 100 of the present embodiment is configured with the engine body 1 and the later-described ATD 43 which is arranged on the engine body 1.

First, the basic configuration of the engine body 1 included in the engine 100 will be explained. Note that, in the explanation below, the vertical direction of the engine 100 illustrated in FIG. 1 is referred to as the height direction. The engine 100 has an elongated approximately rectangular shape in a plan view, and the longitudinal direction thereof is aligned with the direction in which the crankshaft 10 extends. In the explanation below, the longitudinal direction of the engine 100 means the direction of the rotation axis of the crankshaft 10. Further, the direction perpendicular to both of the height direction and the longitudinal direction is referred to as the width direction of the engine 100.

As illustrated in FIG. 1, etc., the engine body 1 is mainly configured with the oil pan 11, the cylinder block 12, the cylinder head 13, and the head cover 14, which are arranged in order from below.

The oil pan 11 is disposed at a lower part (lower-side end part) of the engine 100. The oil pan 11 is formed in the shape of a container whose upper part is open. Inside the oil pan 11, engine oil for lubricating the engine 100 is stored.

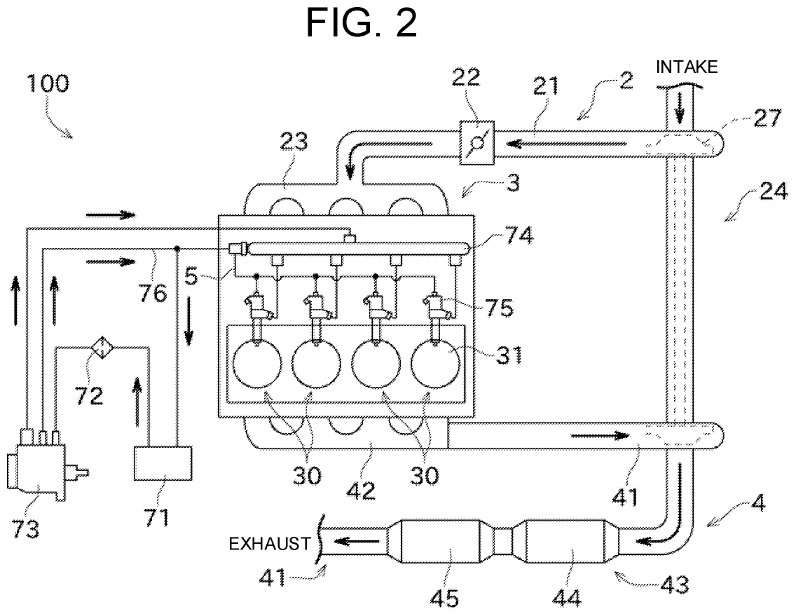

The cylinder block 12 is mounted on the upper side of the oil pan 11. A recess part for housing the crankshaft 10, etc., which is not illustrated in the drawings, is formed in the lower part of the cylinder block 12. Although omitted in FIG. 1, the multiple cylinders 30 are formed on the upper part of the cylinder block 12 as illustrated in FIG. 2. The four cylinders 30 are arranged side by side along the axial direction of the crankshaft 10.

A piston is housed in each cylinder 30. The piston inside a cylinder 30 can move in the vertical direction. The piston is connected to the crankshaft 10 via a connecting rod which is not illustrated in the drawings. The crankshaft 10 rotates as the pistons reciprocate in the respective cylinders 30.

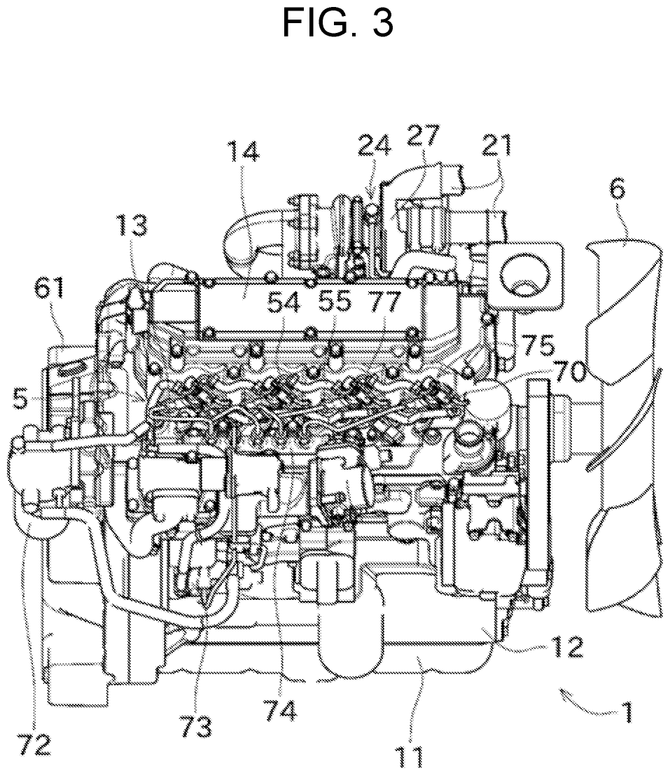

As illustrated in FIG. 3, etc., the cylinder head 13 is mounted on the upper side of the cylinder block 12. The cylinder head 13 and the cylinder block 12 form the combustion chambers 31 illustrated in FIG. 2 corresponding to the respective cylinders 30.

The head cover 14 is disposed on the upper side of the cylinder head 13. Inside the head cover 14, there is housed a valve operating mechanism configured with a push rod, rocker arm, etc., which are not illustrated in the drawings, for operating an intake valve and exhaust valve, which are not illustrated in the drawings.

On one side of the longitudinal direction of the engine 100, the cooling fan 6 for cooling the cooling water of the engine 100 is mounted in a rotatable manner. The flywheel housing 61 which houses a flywheel, which is not illustrated in the drawings, is arranged on the other side (opposite side of the cooling fan 6) of the longitudinal direction of the engine 100.

Subsequently, focusing on the intake and exhaust flows, the configuration of the engine 100 of the present embodiment will be briefly explained with reference to FIG. 2, etc.

As illustrated in FIG. 2, the engine 100 includes the intake unit 2, the power generation unit 3, and the exhaust unit 4 as main configurations.

The intake unit 2 takes air in from the outside. The intake unit 2 includes the intake pipe 21, the throttle valve 22, the intake manifold 23, and the turbocharger 24.

The intake pipe 21 configures an intake passage, so that the air taken in from the outside can flow to the inside.

The throttle valve 22 is arranged in the middle part of the intake passage. The throttle valve 22 changes the cross-sectional area of the intake passage by changing its opened degree according to a control command from a control device which is not illustrated in the drawings. Accordingly, the amount of air supplied to the intake manifold 23 can be adjusted.

The intake manifold 23 is connected to the downstream end part of the intake pipe 21 in the direction of the intake flow. The intake manifold 23 distributes the air supplied via the intake pipe 21 according to the number of cylinders 30 and supplies the air to the combustion chambers 31 formed in the respective cylinders 30.

The power generation unit 3 is configured with the multiple (four in the present embodiment) cylinders 30. The power generation unit 3 generates power to reciprocate the pistons by burning fuel in the combustion chambers 31 formed in the respective cylinders 30.

Specifically, in each combustion chamber 31, the air supplied from the intake manifold 23 is compressed, and then the fuel supplied from a fuel supply unit, which is not illustrated in the drawings, is injected. Accordingly, combustion occurs in the combustion chambers 31, so that the pistons can be reciprocated up and down. The power thereby obtained is transmitted to an appropriate device on the downstream side of the power via the crankshaft 10, etc.

The turbocharger 24 utilizes the flow of exhaust gas discharged from the combustion chambers 31 in order to rotate the included compressor 27, so that the air purified by an air cleaner, which is not illustrated in the drawings, is compressed and forcibly taken in.

The exhaust unit 4 discharges the exhaust gas generated in the combustion chambers 31 to the outside. The exhaust unit 4 includes the exhaust pipe 41, the exhaust manifold 42, and the ATD 43. ATD is an abbreviation for After Treatment Device.

The exhaust pipe 41 configures an exhaust gas passage, and the exhaust gas discharged from the combustion chambers 31 can flow to the inside thereof.

The exhaust manifold 42 is connected to the upstream end part of the exhaust pipe 41 in the direction of the exhaust gas flow. The exhaust manifold 42 collectively guides the exhaust gas generated in each combustion chamber 31 to the exhaust pipe 41.

The ATD 43 is a device that performs post-treatment of exhaust gas. The ATD 43 purifies exhaust gas by removing harmful components such as NOx (nitrogen oxides), CO (carbon monoxide), and HC (hydrocarbons) and particulate matter (PM) contained in the exhaust gas. The ATD 43 is arranged in the middle part of the exhaust pipe 41. The ATD 43 may be supported above the engine body 1 or may be disposed separately from the engine body 1.

The ATD 43 includes the DPF device 44 that removes carbon monoxide, nitrogen monoxide, particulate matter, and the like, which are contained in the exhaust gas, and the SCR device 45 that removes NOx contained in the exhaust gas. DPF is an abbreviation for Diesel Particulate Filter. SCR is an abbreviation for Selective Catalytic Reduction. Note that, without being limited thereto, the ATD 43 may only include the DPF device 44.

Next, a configuration for supplying and injecting fuel in the engine 100 of the present embodiment will be briefly explained.

As illustrated in FIG. 2, the engine 100 includes the fuel filter 72, the fuel pump 73, the common rail 74, the injector 75, the excess fuel return pipe 5, and the fuel restoration pipe 76.

The engine 100 takes in fuel from the fuel tank 71, which is for storing fuel, via the fuel pump 73. The fuel taken in by the fuel pump 73 passes through the fuel filter 72, so that dust and dirt contained in the fuel are thereby removed. Thereafter, the fuel is supplied to the common rail 74. The common rail 74 stores fuel at high pressure and distributes the fuel to the multiple injectors 75 (four in this embodiment).

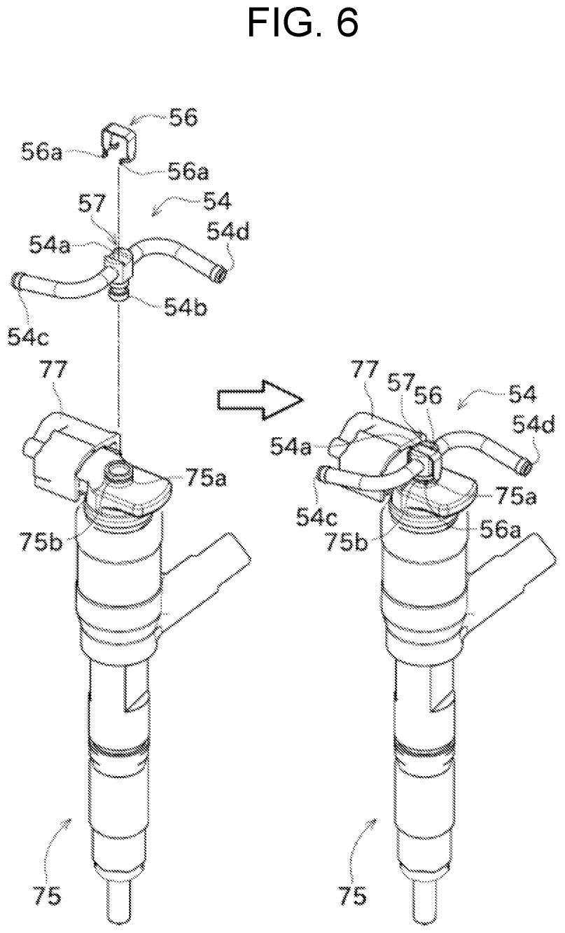

The injectors 75 inject fuel into the combustion chambers 31. As illustrated in FIG. 1, the injectors 75 are aligned along a straight line parallel to the longitudinal direction of the engine 100 and are mounted on the cylinder head 13. As illustrated in FIG. 6, an injector 75 is formed in an elongated approximately cylindrical shape.

The injector 75 include a fuel injection valve, which is not illustrated in the drawings. An ECU (Engine Control Unit), which is not illustrated in the drawings but is a control device of the engine 100, is electrically connected to the fuel injection valve. The fuel injection valve opens and closes at the timing according to a signal from the ECU. Accordingly, the injectors 75 inject fuel into the combustion chambers 31.

As illustrated in FIG. 1, etc., the injector 75 includes the signal line connecting unit 77. The electrical signal line 70 which transmits an instruction signal from the ECU is connected to the signal line connecting unit 77. The signal line connecting unit 77 is configured with, for example, a connector or the like.

As illustrated in FIG. 1 and FIG. 3, etc., the later-described excess fuel return pipe (fuel pipe) 5 is mounted on the top of each injector 75. The excess fuel in each injector 75 is collected to the fuel tank 71 via the excess fuel return pipe 5 and the fuel restoration pipe 76 which is connected to the common rail 74.

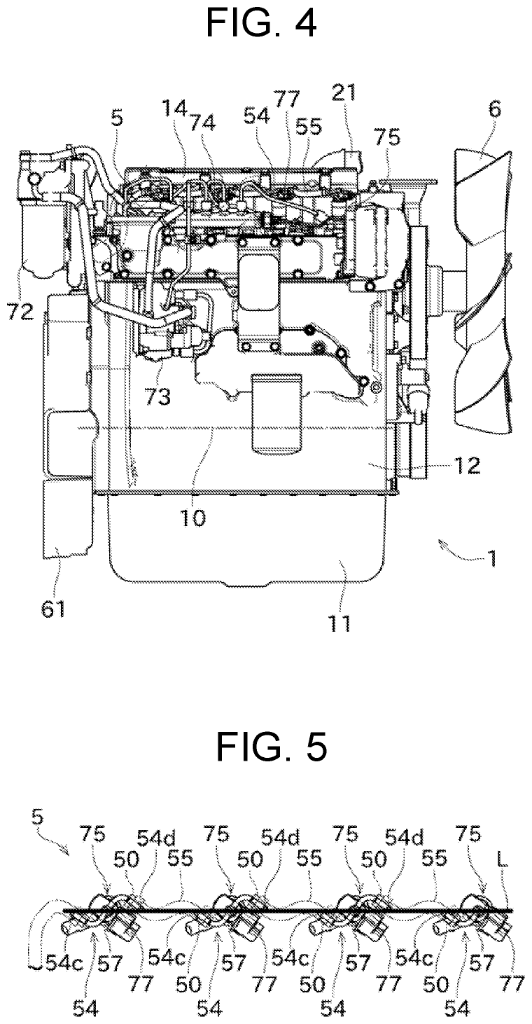

Subsequently, the configuration and arrangement of the excess fuel return pipe 5 mounted on the injectors 75 will be explained with reference to FIG. 3 through FIG. 6. FIG. 3 is a perspective view illustrating the configuration of the engine body 1. FIG. 4 is a side view illustrating the configuration of the engine body 1. FIG. 5 is a diagram illustrating the arrangement of the excess fuel return pipe 5 viewed in the axial direction of the injectors 75. FIG. 6 is a perspective view illustrating how the injector connecting pipe 54 is mounted on the injector 75.

Firstly, the configuration for mounting the excess fuel return pipe 5 onto the injectors 75 will be briefly explained with reference to FIG. 6.

As illustrated in FIG. 6, the connecting pipe mounting unit 75a in a cylindrical shape is formed at the top of the injector 75 (at the end part opposite to the side of being inserted into the cylinder head 13). The later-described injector insertion unit 54b can be inserted into the connecting pipe mounting unit 75a.

The auxiliary fixing member hooking groove 75b for hooking the later-described auxiliary fixing member 56 is formed on the outer periphery of the connecting pipe mounting unit 75a. As illustrated in FIG. 6, the auxiliary fixing member hooking groove 75b is configured with a ring-shaped groove formed on the outer periphery of the connecting pipe mounting unit 75a.

As illustrated in FIG. 5, etc., the excess fuel return pipe 5 of the present embodiment includes the multiple injector connecting pipes (first pipes) 54 and multiple linking pipes (second pipes) 55.

As illustrated in FIG. 5, the injector connecting pipes 54 are formed in an approximate S-shape when viewed in an orientation along the axial direction of the injectors 75. The injector connecting pipes 54 are formed, for example, by bending a metal pipe. The injector connecting pipes 54 have sufficient rigidity, so that the shape thereof can be stably maintained.

The outer diameter of the injector connecting pipes 54 is approximately the same as the inner diameter of the later-described linking pipes 55. The injector connecting pipes 54 are inserted into the linking pipes 55 so as to be connected to the linking pipe 55.

As illustrated in FIG. 6, the auxiliary fixing member mounting groove 54a and the injector insertion unit 54b are formed in the central part (injector connecting unit) 57 of the injector connecting pipe 54. With this auxiliary fixing member mounting groove 54a, the later described auxiliary fixing member 56 can be engaged.

The injector insertion unit 54b is formed in a cylindrical shape extending in the axial direction of the injector 75. The injector insertion unit 54b protrudes downwardly from the above-described approximate S-shaped part. When viewed in a direction perpendicular to the axial direction of the injector 75, the injector connecting pipe 54 is formed in an approximate T-shape.

As illustrated in FIG. 6, the auxiliary fixing member 56 is formed in an inverted U-shape so that the lower side thereof is open. The auxiliary fixing member 56 has a pair of arms, and the hooking units 56a to be hooked onto the auxiliary fixing member hooking groove 75b of the injector 75 are formed at the lower end of each arm. Two hooking units 56a are arranged per arm. As illustrated in FIG. 6, each of the hooking units 56a has a curved shape so as to project to the central side of the auxiliary fixing member 56.

With this configuration, the injector connecting pipe 54 is mounted on the connecting pipe mounting unit 75a of the injector 75 by the auxiliary fixing member 56 in a state where the injector insertion unit 54b is inserted into the connecting pipe mounting unit 75a.

Specifically, as illustrated in FIG. 6, the middle part of the auxiliary fixing member 56 is engaged with the auxiliary fixing member mounting groove 54a of the injector connecting pipe 54. Further, the hooking units 56a are engaged with the auxiliary fixing member hooking groove 75b of the injector 75.

In this way, the hooking units 56a of the auxiliary fixing member 56 are hooked onto the auxiliary fixing member hooking groove 75b, so that the position of the injector connecting pipe 54 in the axial direction of the injector 75 is thereby fixed. Accordingly, the injector insertion unit 54b of the injector connecting pipe 54 can be held so as not to slip out of the injector 75.

Since the auxiliary fixing member hooking groove 75b is formed in a ring shape, the hooking units 56a of the auxiliary fixing member 56 can move in the circumferential direction along the groove. Therefore, the injector connecting pipe 54 is rotatable together with the auxiliary fixing member 56 with respect to the injector 75.

As described above, the injector connecting pipe 54 is mounted on the connecting pipe mounting unit 75a of the injector 75 via the auxiliary fixing member 56 in a rotatable manner with respect to the injector 75.

Since the injector connecting pipe 54 is mounted on the top of the injector 75, the injector connecting pipe 54 can be easily mounted on the injector 75 even after the injector 75 is mounted on the cylinder head 13. Furthermore, since the injector connecting pipe 54 is mounted on the injector 75 in a rotatable manner, the posture of the injector connecting pipe 54 can be easily adjusted even after mounted on the injector 75.

As illustrated in FIG. 4, when viewed in an orientation along the width direction of the engine 100, the injector connecting pipe 54 mounted on the injector 75 is arranged at such a position that at least a part thereof overlaps the signal line connecting unit 77 of the injector 75. That is, the injector connecting pipe 54 and the signal line connecting unit 77 are arranged so as to be at almost the same height.

Accordingly, the injector connecting pipe 54 can be arranged so as to pass in the vicinity of the injector 75. Further, compactness in the height direction of the engine 100 can be achieved.

As explained above, the four injectors 75 of the present embodiment are arranged side by side along a straight line extending in the longitudinal direction of the engine 100. Therefore, as illustrated in FIG. 5, each of the central parts 57 (that is, the injector insertion units 54b) of the injector connecting pipes 54 mounted on the respective injectors 75 is located on the same straight line L.

The injector connecting pipe 54 has a smaller diameter than that of the later-described linking pipe 55, and, as illustrated in FIG. 1 and FIG. 3, at least a part thereof is arranged so as to pass between the signal line connecting unit 77, which is included in the injector 75, and the head cover 14. Accordingly, since the injector connecting pipe 54 can be arranged even in a narrow space between the signal line connecting unit 77 and the head cover 14 while securing a large clearance between the head cover 14 and the signal line connecting unit 77, compactness of the engine 100 can be achieved.

As illustrated in FIG. 5, etc., the injector connecting pipe 54 is formed so that both end parts 54c and 54d and central part 57 thereof are located approximately on the same line.

The linking pipe 55 is formed of a resin material or the like and has certain elasticity. The linking pipe 55 is formed to have a curved shape in its natural state. As illustrated in FIG. 5, the linking pipe 55 is formed in an approximate S-shape when viewed in an orientation along the axial direction of the injector 75.

As illustrated in FIG. 5, etc., each linking pipe 55 links two injector connecting pipes 54 that are adjacent to each other in a mutually-linked manner. Since the linking pipe 55 is configured to be elastically deformable, when the linking pipe 55 is mounted on the injector connecting pipes 54, the linking pipe 55 can be arranged so as to be slightly stretched or compressed from its natural state between the injector connecting pipe 54 and the injector connecting pipe 54.

When mounting the linking pipe 55 onto the injector connecting pipes 54, the injector connecting pipes 54 are tightened from the outside with publicly-known fixing members in a state where the injector connecting pipes 54 are inserted into the linking pipe 55. Accordingly, the linking pipe 55 can be fixed to the injector connecting pipes 54.

In this way, the multiple injector connecting pipes 54 are linked via the linking pipes 55 so as to configure the excess fuel return pipe 5. As illustrated in FIG. 5, this excess fuel return pipe 5 is formed in a zigzag shape with a series of S-shapes having the center on the straight line L. Further, the excess fuel return pipe 5 has such a configuration that, in the direction of the straight line L, rigid parts formed with the injector connecting pipes 54 and elastic parts formed with the linking pipes 55 are alternately arranged.

Accordingly, the excess fuel return pipe 5 can be deformed so as to stretch or compress to some extent as a whole in the direction of the straight line L. As a result, when mounting the excess fuel return pipe 5 onto the injectors 75, the positions of the respective injector connecting pipes 54 can be adjusted in the direction of the straight line L, so that a mounting error (for example, an error in the mounting positions of the injector connecting pipes 54 and the linking pipes 55) can be absorbed. Further, even if the excess fuel return pipe 5 is stretched in the direction of the straight line L, the shape thereof can be preferably maintained, so that the work for mounting can be easily performed.

Further, with the injector connecting pipes 54 having rigidity, the shape of the excess fuel return pipe 5 can be preferably maintained, so that the clearance between the excess fuel return pipe 5 and other components arranged around the excess fuel return pipe 5 can be preferably maintained.

In the present embodiment, the linking pipes 55 are configured to be elastically deformable. With this elastic deformation, a dimensional error, etc., of the injector connecting pipes 54 can be absorbed, for example.

However, as explained below, the elastic deformation of the linking pipes 55 is also used for stabilizing the path of the excess fuel return pipe 5.

Specifically, it can be explained that, in the present embodiment, before mounting the injector connecting pipes 54 onto the injectors 75, a subassembly is made by linking the four injector connecting pipes 54 to each other with the linking pipes 55. This subassembly corresponds to the excess fuel return pipe 5. Since the work of linking the injector connecting pipes 54 and the linking pipes 55 can be performed in a large work space at a location away from the engine 100, the ease of assemblage is improved.

Regarding this subassembly, the interval of the injector connecting pipes 54 is intentionally made slightly shorter than the interval of the injectors 75, which are the assemblage counterparts. In this way, when the four injector connecting pipes 54 of the subassembly are respectively mounted on the injectors 75, the linking pipes 55 are slightly stretched between the injector connecting pipes 54. As a result, the linking pipes 55 can be prevented from loosing, and thus the linking pipe 55 can be prevented from making contact with other members, etc.

In the present embodiment, the pipe connecting units 50 are arranged side by side along the same straight line L across the three linking pipes 55 in a state where the above-described subassembly is assembled to the engine 100. Specifically, it is said that, in the respective injector connecting pipes 54, the end parts 54c and 54d that are linked to the linking pipes 55 are located on the same straight line L as illustrated in FIG. 5. Further, the central parts 57 of the injector connecting pipes 54 are arranged so as to overlap this straight line L.

As described above, although the linking pipes 55 are stretched when the subassembly is assembled to the engine 100, the linking pipes 55 exert a reaction force that stretches the injector connecting pipes 54 against it. However, the injector connecting pipes 54 are hardly rotated by the above-described reaction force because of the layout of the pipe connecting units 50 located along the same straight line L as described above. Therefore, the positions of the linking pipes 55 when assembled can be easily stabilized, and thus the ease of assemblage can be improved.

As explained above, the engine 100 of the present embodiment has the engine body 1 in which the combustion chambers 31 are formed. This engine 100 includes the multiple injectors 75 and the excess fuel return pipe 5. The injectors 75 inject fuel from the fuel tank 71 into the combustion chambers 31. The excess fuel return pipe 5 returns the excess fuel from the multiple injectors 75 to the fuel tank 71. The excess fuel return pipe 5 includes the multiple injector connecting pipes 54 and multiple linking pipes 55. The linking pipes 55 are configured with elastically deformable hoses. Each of the multiple injector connecting pipes 54 is connected to the corresponding injector 75. Each of the multiple linking pipes 55 links two injector connecting pipes 54 that are adjacent to each other. Across the multiple linking pipes 55, the pipe connecting units 50 with which the injector connecting pipes 54 and the linking pipes 55 are connected are arranged side by side along the same straight line L.

Accordingly, since a part of the excess fuel return pipe 5 is configured with a hose that is formed to be elastically deformable, even in a case where such an assemblage method in which the excess fuel return pipe 5 is mounted onto the injectors 75 after the excess fuel return pipe 5 is assembled in advance by connecting the injector connecting pipes 54 and the linking pipes 55, an assemblage error can be easily absorbed. Further, since the pipe connecting units 50 are arranged on the same straight line L across the multiple linking pipes 55, even if the linking pipes 55 arranged between the injector connecting pipes 54 stretch the injector connecting pipes 54, the injector connecting pipes 54 are unlikely to rotate. Therefore, the shape of the excess fuel return pipe 5 can be stably maintained in the state of being assembled to the injectors 75.

Further, in the engine 100 of the present embodiment, the injector connecting pipes 54 are mounted on the injectors 75 in a rotatable manner with respect to the injectors 75.

Accordingly, in the process of mounting the excess fuel return pipe 5 onto the injectors 75, the orientations of the respective injector connecting pipes 54 in relation to the injectors can be changed. Therefore, the excess fuel return pipe 5 can be easily mounted on the injectors 75.

Further, in the engine 100 of the present embodiment, the injector connecting pipes 54 have the central parts 57. The central parts 57 are connected to the injectors 75. When viewed in an orientation along the axial direction of the injectors 75, the central parts 57 are positioned so as to overlap the above-described straight line L.

Accordingly, even if a reaction force in a case where the linking pipes 55 are elastically deformed for absorbing an assemblage error or the like is applied to the first pipes, the reaction force can be received by the first pipes in a well-balanced manner.

Further, in the engine 100 of the present embodiment, the injector connecting pipes 54 are formed in an S-shape when viewed in an orientation along the axial direction of the injectors 75.

Accordingly, the fuel pipes can be arranged while avoiding various surrounding members (for example, the signal line connecting units 77 and the head cover 14).

Further, in the engine 100 of the present embodiment, the linking pipes 55 are configured with hoses formed to have a curved shape in its natural state.

Accordingly, the curved shaped linking pipes 55 can be easily obtained. Further, since the linking pipes 55 are curved from the beginning, the zigzag-shaped excess fuel return pipe 5 can be realized without excessive deformation of the linking pipes 55.

Further, in the engine 100 of the present embodiment, the injectors 75 include the signal line connecting units 77 to which the electrical signal line 70 is connected. The injector connecting pipes 54 and the signal line connecting units 77 are arranged so as to at least partially overlap when viewed in a direction (the width direction of the engine 100) perpendicular to both of the height direction of the engine body 1 and the crankshaft direction.

Accordingly, the injector connecting pipes 54 and the signal line connecting units 77 can be compactly arranged as a whole.

Further, in the engine 100 of the present embodiment, the engine body 1 includes the cylinder head 13 and the head cover 14. The injectors 75 are mounted on the cylinder head 13. The head cover 14 covers the cylinder head 13. The injector connecting pipes 54 are arranged so as to at least partially pass between the signal line connecting units 77 and the head cover 14.

Accordingly, the injector connecting pipes 54 can be arranged by use of the space between the signal line connecting units 77 and the head cover 14. Therefore, compactness of the engine 100 can be achieved.

Although the preferred embodiment of the present invention is explained above, the above-described configuration can be modified as described below, for example.

If necessary, the shapes of the injector connecting pipes 54 and the linking pipes 55 can be appropriately changed.

The structure for mounting the injector connecting pipes 54 onto the injectors 75 is not limited to the structure explained above and can be appropriately modified. For example, it is also possible that the injector connecting pipes 54 are fixed so as not to be rotatable with respect to the injectors 75.

The engine 100 of the present embodiment may be configured as a two-valve mechanism in which one throttle valve and one exhaust valve are respectively disposed or as a four-valve mechanism in which two throttle valves and two exhaust valves are respectively disposed.

### DESCRIPTION OF REFERENCE NUMERALS

1 Engine body
5 Excess fuel return pipe (fuel pipe)
31 Combustion chamber
50 Pipe connecting unit
54 Injector connecting pipe (first pipe)
55 Linking pipe (second pipe)
57 Central part (injector connecting unit)
71 Fuel tank
75 Injector
100 Engine

1. An engine having an engine body in which a combustion chamber is formed, the engine comprising:
a plurality of injectors to inject fuel from a fuel tank into the combustion chamber; and
a fuel pipe to return excess fuel from the plurality of injectors into the fuel tank,
the fuel pipe comprising:
a plurality of first pipes; and
a plurality of second pipes configured with hoses that are elastically deformable,
wherein the plurality of first pipes are respectively connected to the corresponding injectors,
the plurality of second pipes respectively link two of the first pipes that are adjacent to each other, and
across the plurality of second pipes, pipe connecting units with which the first pipes and the second pipes are connected are arranged side by side along a same straight line.

2. The engine according to claim 1,
wherein the first pipes are mounted on the injectors in a rotatable manner with respect to the injectors.

3. The engine according to claim 1,
wherein the first pipes comprise an injector connecting unit to be connected to the injectors, and
when viewed in an orientation along an axial direction of the injectors, the injector connecting unit is located so as to overlap the straight line.

4. The engine according to claim 1,
wherein, when viewed in an orientation along an axial direction of the injectors, the first pipes are formed in an S-shape, and central parts of the first pipes are connected to the injectors.

5. The engine according to claim 1,
wherein the second pipes have a curved shape in a natural state thereof.

6. The engine according to claim 1,
wherein the injectors comprise a signal line connecting unit to which an electrical signal line is connected, and
when viewed in a direction perpendicular to both of a height direction of the engine body and a direction of a crankshaft, the first pipes and the signal line connecting unit are arranged to at least partially overlap with each other.

7. The engine according to claim 6,
wherein the engine body comprises a cylinder head, on which the injectors are mounted, and a head cover, which covers the cylinder head, and
the first pipes are arranged so as to at least partially pass between the signal line connecting unit and the head cover.
